(19) United States
(12) Patent Application Publication
(10) Pub. No.: US 2020/0376928 A1
(43) Pub. Date: Dec. 3, 2020

(54) ELECTRIC HEATING APPLIANCE

(71) Applicant: Webasto SE, Stockdorf (DE)

(72) Inventors: CHRISTIAN BAECKER, Stockdorf (DE); MICHAEL POEHNER, Stockdorf (DE); UWE STRECKER, Stockdorf (DE); WERNER VOGL, Stockdorf (DE); NIKOLAUS GEBHARDT, Stockdorf (DE); NILS ELM, Stockdorf (DE); JENS WIESKE, Stockdorf (DE)

(21) Appl. No.: 16/496,521

(22) PCT Filed: Mar. 20, 2018
(86) PCT No.: PCT/EP2018/056935

§ 371 Date: Sep. 23, 2019

(30) Foreign Application Priority Data
Mar. 23, 2017 (DE) 10 2017 106 251.3

(51) Int. Cl. B60H 1/22

(52) U.S. Cl. CPC B60H 1/2221; H05B 1/0236; B60H 1/2218

(57) ABSTRACT

The disclosure relates to an electric heating device, particularly a parking heater, for a motor vehicle, wherein the electric heating device is configured to be connected to an external system voltage and to be incorporated in an on-board motor vehicle cooling circuit, comprising at least one electric heating element for the delivery of heat to a coolant fluid which is present in the cooling circuit, and a power supply unit for the transformation of the external system voltage. Outputs for battery charging, the operation of a circulation pump or the operation of a vehicle fan.

### CROSS-REFERENCE TO RELATED APPLICATIONS

This application represents the national stage entry of PCT International Patent Application No. PCT/EP2018/056935 filed on Mar. 20, 2018 and claims priority to German Patent Application No. DE 10 2017 106 251.3 filed Mar. 23, 2017. The contents of these applications are hereby incorporated by reference as if set forth in their entirety herein.

### DESCRIPTION

The disclosure relates to an electric heating device, particularly a parking heater, for a motor vehicle according to Claim 1, and to a method for operating such a heating device.

Parking heaters for motor vehicles are generally known from the prior art. A known concept involves here pre-heating of the engine, with no heating of the passenger compartment. This pre-heating, in part, is executed exclusively by convection, with no circulation pump for the cooling water. A further known concept involves a modular system, with separate components for the engine pre-heater and heating of the passenger compartment (and battery charging, where applicable).

Devices for engine pre-heating only, at least in the cold season of the year, are disadvantageous, as heat-up of the passenger compartment, or demisting of the windows, does not occur.

Systems of modular design require the installation of a plurality of components. The passenger compartment is heated by electric heaters, which are provided with a dedicated fan. These are visible in the passenger compartment (together with cabling, in some cases) or are installed, for example, under the passenger seat, such that de-icing of the window is not possible, or only possible to a limited extent.

Systems which are operated via the cigarette lighter, or are directly connected to the vehicle battery, have only a limited heating capacity, and the operation thereof drains the battery. In the event of prolonged use, the battery can be discharged to the extent that the vehicle can no longer be started.

The object of the disclosure is the proposal of an electric heating device, particularly a parking heater, for a motor vehicle, and of a method for operating a heating device, which are to permit engine pre-heating and the heating of the passenger compartment in an effective and space-saving manner. A further object of the is the proposal of a corresponding system, and of a motor vehicle having a heating device of this type.

This object is particularly fulfilled by a heating device, preferably by a parking heater, for a motor vehicle (e.g. a private car or an HGV), wherein the electric heating device is configured to be connected to an external voltage supply (e.g. a public electric grid system) and to be incorporated in an on-board motor vehicle cooling circuit, comprising at least one heating element for the delivery of heat to a coolant fluid (particularly cooling water) which is present in the cooling circuit, and a power supply unit for the transformation of a system voltage of the external voltage supply into a local voltage (particularly a DC voltage) for the supply of a further component or a plurality of further components (of the vehicle, particularly heat-up or heating devices of the vehicle), particularly a circulation pump (for the coolant fluid), and/or a vehicle fan, and/or for the charging of a battery. A control unit (for the output of a control signal) can be provided herein for the control of a vehicle fan of the motor vehicle and/or for the control of charging of a battery of the motor vehicle.

A core concept of the disclosure is the equipment of an electric heating device, particularly a parking heater, with an (integrated) power supply unit, by means of which further components, particularly a circulation pump, can be supplied with a local voltage. Preferably, the vehicle fan can additionally be supplied and/or actuated. According to a further concept of the disclosure, this is advantageously combined with a control function for charging of the battery (particularly maintenance charging). To this end, the vehicle fan, which is present in any case, can be employed for the heating of the passenger compartment on the one hand. At the same time, charging of the battery can ensure that (particularly where the vehicle fan is supplied with electric power by a battery) no discharging occurs, to the extent that the vehicle can no longer be started. Overall, efficient and unrestricted heating of the passenger compartment is permitted accordingly.

The heating device can be configured for the output of one or more control signals for the actuation of components, e.g. a circulation pump and/or fan, using the local voltage delivered by the power supply unit, and/or can be configured for the control of a charging function for a/the battery of the motor vehicle.

The vehicle fan is to be understood as a (factory pre-installed) fan in the motor vehicle, which customarily cooperates with a ventilation system which comprises a plurality of air outlet openings (e.g. slots) (for example in the region of the windscreen, or in the vehicle fittings region or in the footwell). The power supply unit and the control unit can be constituted by various components, or by a common component. Moreover, the power supply unit can be configured such that it constitutes at least one part of the control unit (together with further components). The (electrical) heating element is preferably an electrical resistor, for example a tubular heater and/or at least one layer heater. The heating device can already incorporate the circulation pump. However, the latter can also be provided supplementarily (e.g. in a further housing).

The external voltage supply is preferably an AC voltage. The frequency of the system voltage can lie between 40 Hertz and 70 Hertz (particularly ≥50 Hertz or ≤60 Hertz). The system voltage preferably lies between 100 volts and 500 volts. The local voltage can lie between 2 volts and 80 volts, particularly 5 volts and 50 volts. An electric current assigned to the local voltage (on-board voltage) can be a (where applicable, exclusive) direct current (or alternatively, an alternating current).

In a specific form of embodiment, the electric heating device is configured for the supply of the vehicle fan with the local voltage by means of the power supply unit. In this form of embodiment, where applicable, the vehicle fan is thus not only actuated by the electric heating device (and then, for example, supplied with a voltage via the vehicle battery), but the voltage supply itself is also delivered by the electric heating device, namely, the power supply unit thereof. This permits particularly efficient heating of the passenger compartment by simple means.

The control of the charging function for the battery is preferably executed such that maintenance charging is carried out. For example, this can proceed such that, firstly, an actual state of charge is determined (for example at the start time of the operation of the electric heating device), and the battery undergoes a charging process upon the observation of a decline in the actual state of charge at a later time point (for example, by a specific value or by a percentage value), until the original actual state is restored. It is thus achieved that the battery is maintained in a state which would have existed in any event, had the heat-up (heating of the passenger compartment or engine pre-heating) not been executed. Control can also proceed such that the battery is continuously supplied (at least during the operation of the heating system) with a voltage which permits charging (without damaging the battery).

The heating element (where applicable, with its water channel), on the one hand, and the power supply unit and/or the control unit can be arranged in a sub-assembly (where applicable, in a housing). A sub-assembly is particularly to be understood as a constructional unit, in which the heating element and the power supply unit or control unit are arranged in immediate mutual proximity (for example, within a clearance of less than 10 cm or less than 5 cm, or in direct mutual proximity). Where applicable, it can also be provided that the heating element, on the one hand, and the power supply unit and/or the control unit, on the other, are respectively arranged in a separate housing, wherein the resulting plurality of housings are then preferably arranged adjacently to one another (particularly within a clearance of less than 5 cm, or in direct mutual proximity, particularly in mutual contact). Accordingly, a compact electric heating device is proposed, which permits efficient heating of the passenger compartment by simple means.

Preferably, the electric heating element and the power supply unit and/or the control unit are supplied via the same network connection of the electric heating device. Preferably, the electric heating element is thus supplied directly with the system voltage (i.e. with no “detour” via the power supply unit). Overall, this permits efficient operation.

The above-mentioned object is further fulfilled by a system, comprising an electric heating device of the type described above, and (the above-mentioned) circulation pump, and/or a (the above-mentioned) fan, and/or a (the above-mentioned) battery, and/or means for activating the system/heating device, e.g. a remote control and/or a UMTS connection, and/or means for the temperature-dependent activation of the vehicle fan, and/or means for the temperature-dependent control of the water pump.

The above-mentioned object is further fulfilled by a motor vehicle, comprising an electric heating device of the type described above and/or a system of the type described above.

The object is further fulfilled by the application of an electric heating device, preferably a parking heater, particularly of the type described above, of a motor vehicle (particularly of the type described above), wherein the electric heating device is configured to be connected to an external voltage supply and to be incorporated in an on-board motor vehicle cooling circuit, and comprises at least one heating element for the delivery of heat to a coolant fluid which is present in the cooling circuit, for the charging of a battery of the vehicle and/or for the supply of an on-board vehicle

A core concept of the disclosure thus lies in the fact that the electric heating device is employed for the charging of a battery of the vehicle and/or for the supply of an on-board vehicle fan with a supply voltage. Particularly, a power supply unit of the heating device can incorporate a corresponding output, which permits this (or a plurality of outputs).

The heating device, particularly the parking heater, can thus be effectively operated over a prolonged period.

The above-mentioned object is further fulfilled by a method for operating a heating device of the type described above, or a system of the type described above, or a motor vehicle of the type described above, wherein a battery of the vehicle, for the charging thereof, is supplied with electric power by means of the heating device, and/or wherein an on-board vehicle fan is supplied with electric power by means of the heating device, and/or wherein charging of a/the battery of the vehicle is controlled by means of the heating device, and/or wherein operation of a/the on-board vehicle fan is controlled by means of the heating device. Moreover, particularly, the circulation pump is also supplied with a voltage and, where applicable, controlled by means of the electric heating device.

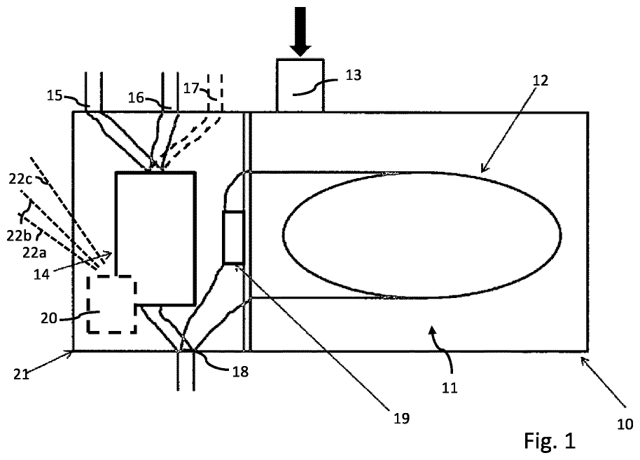

The following description is with respect to an exemplary embodiment which is explained in greater detail with reference to FIG. 1. In the FIGURE:

FIG. 1 shows a schematic representation of a heating device according to the disclosure.

FIG. 1 shows a schematic representation of an electric heating device. The heating device comprises a housing 10 with a water channel 11. In the water channel 11, an electric heating element 12 is arranged such that, when a current flows through the electric heating element, the resulting heat leads to a heat up of a fluid (water) in the water channel 11. The coolant fluid (the cooling water) can be admitted and discharged via (schematically represented) connections 13.

The heating device further comprises a power supply unit 14 and outputs 15, 16 and (optionally) 17 for battery charging, the operation of a circulation pump and (where applicable) the operation of a vehicle fan. Moreover, a network connection 18 is provided, by means of which the electric heating device can be connected to an external voltage supply (public electric grid system). By means of a switch (thermostatic switch) 19, the electric heating element can be switched on. The electric heating element is supplied (directly, i.e. not via the power supply unit) with the external voltage from the public electric grid system. Moreover a control unit 20 is provided (where applicable, at least partly as a constituent of the power supply unit 14), by means of which, where applicable, the circulation pump, and/or the battery charging function, and/or the vehicle fan can be actuated via one or more outputs 22a, 22b, 22c.

The power supply unit 14 can be arranged in an installation space 21 (where applicable, in combination with the control unit). This installation space, together with the electric heating element, can be provided in a common housing, or accommodated by a separate housing (which is nevertheless arranged on the housing in which the electric heating element is arranged).

In the form of embodiment according to FIG. 1, heat is evacuated directly to the cooling water. The power supply unit 14 permits transformation of the supply voltage (e.g. 230 volts) to, for example, (approximately) 13.8 volts for a supply of the circulation pump and, where applicable, the vehicle fan.

At this point, it should be observed that all the above-mentioned components, considered individually per se and in any combination, particularly the details represented in the drawings, are claimed as essential to the disclosure. Variations herefrom will be familiar to a person skilled in the art.

### REFERENCE NUMBERS

10 Housing
11 Water channel
12 Electric heating element
13 Connection
14 Power supply unit
15 Output for a circulation pump
16 Output for the battery charging function
17 Output for a fan
18 Network connection
19 Switch
20 Control unit
21 Installation space

1. Electric heating device for a motor vehicle, wherein the electric heating device is configured to be connected to an external system voltage and to be incorporated in an on-board motor vehicle cooling circuit, comprising at least one electric heating element for the delivery of heat to a coolant fluid which is present in the cooling circuit, and a power supply unit for the transformation of the external system voltage into a local voltage.

2. Electric heating device according to claim 1,
wherein
the external system voltage lies between 100 V and 500 V, and/or a frequency of the system voltage lies between 50 Hz and 60 Hz, and/or the local voltage lies between 5 V and 50 V.

3. Electric heating device according to claim 1,
wherein
the heating device is configured for the output of one or more control signals for the actuation of components, e.g. a circulation pump and/or fan, using the local voltage delivered by the power supply unit, and/or is configured for the control of a charging function for a battery of the motor vehicle.

4. Electric heating device according to claim 3,
wherein
the control of the charging function for the battery executes a maintenance charging function.

5. Electric heating device according to claim 1,
wherein
the heating element, on the one hand, and the power supply unit and/or the control unit, on the other hand, are arranged in a sub-assembly or in a housing, where applicable.

6. Electric heating device according to claim 1,
wherein
the electric heating element and the power supply unit and/or the control unit are supplied via the same network connection.

7. System, comprising the electric heating device according claim 1, together with the circulation pump, and/or the fan, and/or a battery, and/or means for activating the system/heating device, e.g. a remote control and/or a UMTS connection, and/or means for the temperature-dependent activation of the vehicle fan, and/or means for the temperature-dependent control of the water pump.

8. Motor vehicle, comprising an electric heating device according to claim 1.

9. Application of an electric heating device according to claim 1 wherein the electric heating device is configured to be connected to an external voltage supply and to be incorporated in an on-board motor vehicle cooling circuit, and comprises at least one heating element for the delivery of heat to a coolant fluid which is present in the cooling circuit, for the charging of a of the vehicle and/or for the supply of an on-board vehicle fan with a supply voltage, and/or for the supply of a circulation pump.

10. Method for operating a heating device according to claim 1 wherein a battery of the vehicle, for the charging thereof, is supplied with electric power by means of the heating device, and/or wherein an on-board vehicle fan is supplied with electric power by means of the heating device, and/or wherein charging of a battery of the vehicle is controlled by means of the heating device, and/or wherein operation of an on-board vehicle fan is controlled by means of the heating device.

11. Application of a system according to claim 7, wherein the electric heating device is configured to be connected to an external voltage supply and to be incorporated in an on-board motor vehicle cooling circuit, and comprises at least one heating element for the delivery of heat to a coolant fluid which is present in the cooling circuit, for the charging of a of the vehicle and/or for the supply of an on-board vehicle fan with a supply voltage, and/or for the supply of a circulation pump.

12. Method for operating a system according to claim 7, wherein a battery of the vehicle, for the charging thereof, is supplied with electric power by means of the heating device, and/or wherein an on-board vehicle fan is supplied with electric power by means of the heating device, and/or wherein charging of a battery of the vehicle is controlled by means of the heating device, and/or wherein operation of an on-board vehicle fan is controlled by means of the heating device.
